(19) United States
(12) Patent Application Publication
(10) Pub. No.: US 2026/0292335 A1
(43) Pub. Date: Sep. 24, 2026

(54) IMAGING SYSTEMS WITH DYNAMIC IMAGE SENSOR CONFIGURATION ADJUSTMENT

(71) Applicant: OMNIVISION TECHNOLOGIES, INC., Santa Clara, CA (US)

(72) Inventor: Daisuke Saito, Los Altos, CA (US)

(21) Appl. No.: 19/529,008

(22) Filed: Feb. 3, 2026

Related U.S. Application Data
(60) Provisional application No. 63/774,674, filed on Mar. 19, 2025.

(51) Int. Cl. H04N 23/60; H04N 23/71; H04N 25/47; H04N 25/60; H04N 25/77; H04N 25/79

(52) U.S. Cl. CPC H04N 23/665; H04N 23/64; H04N 23/71; H04N 25/47; H04N 25/60; H04N 25/77; H04N 25/79

(57) ABSTRACT

Imaging systems with dynamic image sensor configuration adjustment (and associated systems, devices, and methods) are disclosed herein. In one embodiment, an imaging system includes a pixel array, event detection circuitry, an ambient light monitor, and a sensor controller operably coupled to each of the event detection circuitry and the ambient light monitor. The sensor controller can be configured to (i) receive one or more event signals from the event detection circuitry and an ambient light signal from the ambient light monitor, (ii) determine, based at least in part on the one or more event signals and the ambient light signal, an optimized value for a contrast threshold or another sensor setting of the event detection circuitry that is usable by the imaging system to improve an image quality of one or more images of an external scene, and (iii) communicate the determined optimized value to the event detection circuitry.

### CROSS-REFERENCE TO RELATED APPLICATION(S)

This application claims priority to U.S. Provisional Application No. 63/774,674, filed Mar. 19, 2025, which is hereby incorporated by reference in its entirety.

### TECHNICAL FIELD

This disclosure relates generally to image sensors, and in particular but not exclusively, relates to hybrid image sensors. For example, several embodiments of the present technology described in detail below are directed to on-chip implementations of scene content detection, such as for adjusting nominal contrast thresholds or other configurations of event vision sensors.

### BACKGROUND

Image sensors have become ubiquitous and are now widely used in digital cameras, cellular phones, security cameras, as well as in medical, automotive, and other applications. As image sensors are integrated into a broader range of electronic devices, it is desirable to enhance their functionality, performance metrics, and the like in as many ways as possible (e.g., resolution, power consumption, dynamic range) through both device architecture design as well as image acquisition processing. The technology used to manufacture image sensors has continued to advance at a great pace. For example, the demands of higher resolution and lower power consumption have encouraged the further miniaturization and integration of these devices.

A typical image sensor operates in response to image light from an external scene being incident upon the image sensor. The image sensor includes an array of pixels having photosensitive elements (e.g., photodiodes) that absorb a portion of the incident image light and generate image charge upon absorption of the image light. The image charge photogenerated by the pixels may be measured as analog output image signals on column bitlines that vary as a function of the incident image light. In other words, the amount of image charge generated is proportional to the intensity of the image light, which is read out as analog image signals from the column bitlines and converted to digital values to produce digital images (e.g., image data) representing the external scene. The analog image signals on the bitlines are coupled to readout circuits, which include input stages having analog-to-digital conversion (ADC) circuits to convert those analog image signals from the pixel array into the digital image signals.

### BRIEF DESCRIPTION OF THE DRAWINGS

Non-limiting and non-exhaustive embodiments of the present technology are described below with reference to the following figures, in which like or similar reference numbers are used to refer to like or similar components throughout unless otherwise specified.

FIG. 1 illustrates a stacked hybrid complementary metal oxide semiconductor (CMOS) image sensor (CIS) and event vision sensor (EVS) imaging system configured in accordance with embodiments of the present technology.

FIG. 2 is a schematic block diagram of a model training scheme configured in accordance with embodiments of the present technology.

FIG. 3 is a schematic block diagram of a hybrid imaging system configured in accordance with embodiments of the present technology.

FIG. 4 illustrates an event driven circuit configured in accordance with embodiments of the present technology.

FIG. 5 is a schematic block diagram of an event detection portion of a hybrid imaging system configured in accordance with embodiments of the present technology.

FIG. 6 is a table listing various scene content parameters in accordance with embodiments of the present technology.

FIG. 7 is a flow diagram illustrating a method of operating an imaging system in accordance with embodiments of the present technology.

Skilled artisans will appreciate that elements in the figures are illustrated for simplicity and clarity and are not necessarily drawn to scale. For example, the dimensions of some of the elements in the figures may be exaggerated relative to other elements to aid in understanding of various aspects of the present technology. In addition, common but well-understood elements or methods that are useful or necessary in a commercially feasible embodiment are often not depicted in the figures, or described in detail below, to avoid unnecessarily obscuring the description of various aspects of the present technology.

### DETAILED DESCRIPTION

The present disclosure relates to imaging systems (and associated systems, devices, and methods) that can dynamically optimize hardware operating parameters, such as automatically and/or in real-time. For example, several embodiments of the present technology are directed to image sensors that can be operated in a hybrid mode to simultaneously capture CIS and EVS information, and can determine optimal sensor settings (e.g., optimal nominal contrast thresholds) to improve or maximize image quality. Such image sensors can include a sensor controller that receives event signals and ambient light signals, determines optimal values for one or more sensor settings, and communicates the optimal values to other components of the image sensor, such as event driven circuits.

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

It will be understood that, although the terms first, second, third, etc., may be used in the disclosure and claims to describe various elements, these elements should not be limited by these terms and should not be used to determine the process sequence or formation order of associated elements. Unless otherwise indicated, these terms are merely used to distinguish one element from another element. Thus, a first element discussed below could be termed a second element without departing from the teachings of the disclosed embodiments.

It is appreciated that the term “photosensor” or “photodiode” may correspond to a doped region disposed within the semiconductor material configured to photogenerate image charge(s) (e.g., one or more electrons or holes) in response to incident light. For example, photodiode may correspond to an n-doped region disposed within a p-type semiconductor material or an n-doped region surrounded by a p-type well disposed within the semiconductor material or a p-doped region disposed within an n-type semiconductor.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

### A. OVERVIEW

Many image sensors, such as event vision sensors and hybrid CIS/EVS image sensors, employ event vision pixels that are usable to detect events in an external scene. For example, event vision pixels can detect an event when relative log-luminance in light from the external scene that is incident on the event vision pixels exceeds predefined thresholds (known as contrast thresholds).

When larger contrast thresholds are used, larger relative log-luminance is required before event vision pixels detect events. Thus, use of too large of contrast thresholds can result in an increase of the event vision pixels “missing” legitimate events that occur in an external scene. On the other hand, when smaller contrast thresholds are used, smaller relative log-luminance can trigger event vision pixels to detect events. Thus, use of too small of contrast thresholds can result in the event vision pixels detecting an increased number of noise events, which are events registered by the event vision pixels due to noise instead of legitimate events in the external scene. As such, the quality of event data (and therefore the quality of an image based on the event data) can be directly related to contrast threshold values. Optimal contrast threshold values, however, can be scene- and/or application-specific and can depend on a variety of other factors, such as a coupling capacitor or bias current in the event vision pixels.

The present technology is therefore directed to imaging systems (and associated systems, devices, and methods) that can optimize their own hardware operating parameters (e.g., nominal contrast thresholds), such as automatically and/or in real-time. For example, several embodiments of the present technology are directed to various imaging systems with sensor controllers that are configured to, between CIS image frames, (a) receive one or more inputs (e.g., event signals, ambient light signals, noise signals) and (b) determine optimized values of one or more sensor settings (e.g., nominal contrast threshold values for event vision pixels) based at least in part on the one or more inputs.

In particular, in one embodiment, an imaging system includes a sensor controller that uses data (e.g., event data) measured or obtained to optimize various hardware settings in real-time. The hardware settings to be optimized can include, for example, nominal contrast threshold, coupling capacitance, current applied by a current source, and/or other settings of event driven circuitry. In some embodiments, a learning algorithm is employed to aid in determining the optimal values. In these and other embodiments, a feedback loop is integrated into the system to continuously optimize the hardware settings. In these and still other embodiments, measurements are used to first identify the type and/or situation of the captured external scene, and then a lookup table is referenced to determine optimal values based at least in part on the identified type and/or situation of the captured external scene.

Thus, as will be shown and described in the various examples below, an imaging system configured in accordance with some embodiments of the present technology can include a pixel array, event detection circuitry operably coupled to the pixel array, an ambient light monitor operably coupled to the pixel array, and a sensor controller operably coupled to each of the event detection circuitry and the ambient light monitor. The pixel array can include a plurality of pixels arranged in rows and columns, individual ones of the plurality of pixels including a photosensor configured to generate photocurrent in response to incident light received from an external scene. The event detection circuitry can be configured to receive the photocurrent from the photosensors and output one or more event signals based at least in part on the received photocurrent and a contrast threshold. Each of the one or more event signals can indicate an event detected in the external scene. The ambient light monitor can be configured to output an ambient light signal indicating an ambient light level of the external scene. The sensor controller can be configured to (i) receive the one or more event signals from the event detection circuitry and the ambient light signal from the ambient light monitor, (ii) determine, based at least in part on the received one or more event signals and the received ambient light signal, an optimal value of at least one of the contrast threshold or another sensor setting of the event detection circuitry (e.g., that is expected to improve or maximize an image quality of the external scene), and (iii) communicate, in real-time, the determined optimized value to the event detection circuitry.

A sensor processor included in a hybrid imaging system and configured in accordance with some embodiments of the present technology can include a sensor controller operably coupled to an event detection circuitry of the hybrid imaging system and an ambient light monitor of the hybrid imaging system. The sensor controller can be configured to (i) receive one or more event signals from the event detection circuitry and an ambient light signal from the ambient light monitor, (ii) determine, based at least in part on the received one or more event signals and the received ambient light signal, an optimal value of at least one of a contrast threshold or another sensor setting of the event detection circuitry (e.g., that is expected to improve or maximize an image quality of an external scene), and (iii) communicate, in real-time, the determined optimal value to the event detection circuitry.

A method for operating a hybrid imaging system in accordance with some embodiments of the present technology can include (i) generating, using photosensors of a plurality of pixels included in a pixel array, photocurrent in response to incident light received from an external scene, (ii) outputting, based at least in part on the generated photocurrent and a contrast threshold, one or more event signals, wherein each of the one or more event signals indicates an event detected in the external scene, (iii) providing an ambient light signal indicating an ambient light level of the external scene, (iv) determining, based at least in part on the one or more event signals and the ambient light signal, an optimal value of at least one of the contrast threshold or another sensor setting of the hybrid imaging system (e.g., that is expected to improve or maximize an image quality of the external scene), and (v) communicating, in real-time, the determined optimal value to a component of the hybrid imaging system.

The present technology is expected to offer several advantages. For example, due to different lighting conditions (e.g., bright vs. dim) and/or the causes of events detected (e.g., due to camera motion versus object motion), among other differences, different external scenes may require different hardware settings in order for imaging systems to achieve acceptable, improved, and/or maximum image quality. The present technology is expected to provide hardware (e.g., event driven circuitry hardware) that can adapt to such different external scenes to, for example, improve or maximize the quality of images taken of or in such external scenes. As discussed further herein, embodiments of the present technology can determine optimal sensor settings automatically and/or in real-time based at least in part on measurements of the captured external scene, such as event data, ambient light levels, etc. Therefore, the present technology is expected to adapt to different external scenes automatically and/or in real-time, and thereby consistently provide high image quality.

### B. SELECTED EMBODIMENTS OF IMAGE SENSORS, AND ASSOCIATED SYSTEMS. DEVICES, AND METHODS

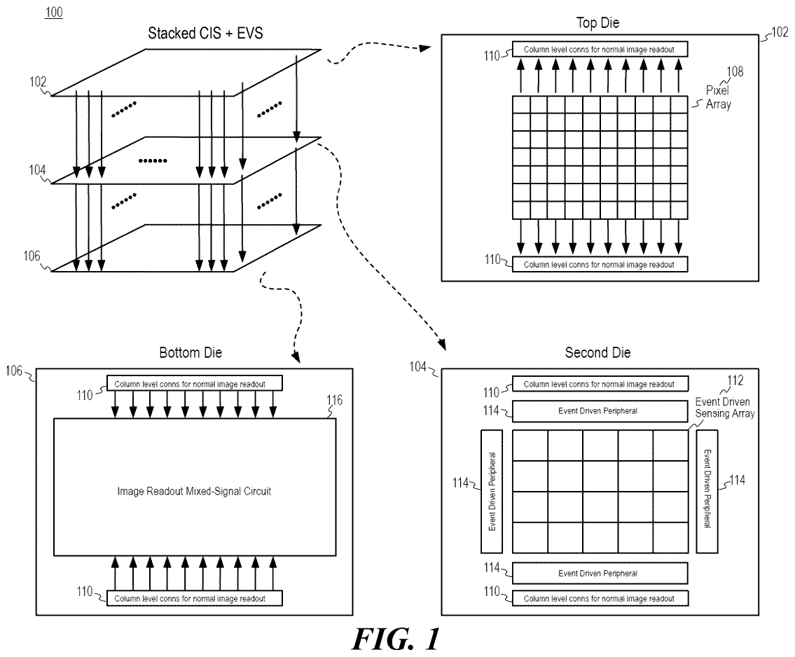

FIG. 1 illustrates a stacked hybrid complementary metal oxide semiconductor (CMOS) image sensor (CIS) and event vision sensor (EVS) imaging system 100 (“the system 100”) configured in accordance with embodiments of the present technology. As shown in the depicted example, the system 100 includes a first die 102, a second die 104, and a third die 106 that are stacked and coupled together in a stacked chip scheme. In various examples, the first die 102, the second die 104, and the third die 106 are semiconductor dies that include a suitable semiconductor material such as silicon. In the example, the first die 102, which may also be referred to as the top die 102 of the system 100, includes a pixel array 108. The third die 106, which may also be referred to as the bottom die 106 of the system 100, includes an image readout circuit 116 (also referred to herein as image readout mixed-signal circuitry). The image readout circuit 116 can be coupled to the pixel array 108 of the top die 102 through column level connections for normal image readout 110. In various examples, the column level connections for normal image readout 110 are implemented from column bitlines of the pixel array 108 with through silicon vias (TSVs) that extend between the top die 102 and the bottom die 106, and are routed through the second die 104.

In various examples, the pixel array 108 is a two-dimensional (2D) array including a plurality of pixels (also referred to as “pixels cells”) that each includes at least one photosensor exposed to incident light. As illustrated in the depicted example, the pixels are arranged into rows and columns to acquire image data of an external scene (e.g., a person, place, object, etc. within the external scene), which can then be used to render images and/or video of the external scene. As discussed further herein, each of the pixels can be a hybrid CIS/EVS pixel including a plurality of photosensors (e.g., photodiodes) configured to photogenerate image charge in response to the incident light. The pixel array 108 can be operated in a CIS-only mode, a hybrid CIS/EVS mode, and/or an EVS-only mode. When operating in the CIS-only or hybrid CIS/EVS mode, the appropriate fraction of the analog image charge data acquired can be read out by the image readout circuit 116 in the bottom die 106 through the column bitlines. In various examples, the image charge from each row of the pixel array 108 can be read out in parallel through column bitlines by the image readout circuit 116.

In various examples, the image readout circuit 116 in the bottom die 106 includes amplifiers, analog to digital converter (ADC) circuitry, associated analog support circuitry, associated digital support circuitry, etc., for normal image readout and processing. In some examples, image readout circuit 116 may also include event driven readout circuitry, which will be described in greater detail below. In operation, the photogenerated analog image charge signals are read out from the pixels of the pixel array 108, amplified, and converted to digital values in the image readout circuit 116. In some examples, the image readout circuit 116 can read out a row of image data at a time. In other examples, the image readout circuit 116 can read out the image data using a variety of other techniques (not illustrated), such as a serial readout or a full parallel readout of all pixels simultaneously. The image data may be stored or even manipulated by applying post image effects (e.g., crop, rotate, remove red eye, adjust brightness, adjust contrast, and the like).

In the depicted example, the second die 104, which may also be referred to as the middle die 104 of the system 100, includes an event driven sensing array 112 that is coupled to the pixel array 108 in the top die 102. In various examples, the event driven sensing array 112 is coupled to the pixels of the pixel array 108 through one or more stacked pixel level connections (SPLC) (e.g., hybrid bonds) disposed between the top die 102 and the middle die 104. In one example, the event driven sensing array 112 includes an array of event driven circuits. As will be discussed, in one example, each of the event driven circuits in the event driven sensing array 112 is coupled to a corresponding one of the plurality of pixels of the pixel array 108 (e.g., through at least one hybrid bond between the top die 102 and the middle die 104) to asynchronously detect events that occur in the light that is incident upon the pixel array 108 in accordance with embodiments of the present technology.

When operating in the hybrid CIS/EVS or EVS-only mode, the appropriate fraction of the photosensors of each of the pixels of the pixel array 108 can be used to track changes in the intensity of light incident on the photosensors from an external scene. In particular, the photosensors can photogenerate image charge (electrons or holes) or photocurrent in response to the incident light from the external scene. The photogenerated image can then be provided, via an EVS connection such as a hybrid bond, to a coupled event driven circuit of the event driven sensing array 112. In some embodiments, each event driven circuit includes (i) a photocurrent-to-voltage converter coupled to one or more photosensors of the corresponding pixel to convert photocurrent generated by the one or more photosensors to a voltage, and (ii) a difference circuit coupled to the photocurrent-to-voltage converter and configured to generate a difference signal or analog signal level (e.g., a logarithmic difference voltage relative to a reset time) based at least in part on the voltage. The event driven sensing array 112 and/or event driven peripheral circuitry 114 on the middle die 104 can further include a threshold comparison stage to determine and generate event detection signals in response to events asynchronously detected in incident light received from the external scene. For example, the threshold comparison stage may generate an event detection signal when a detected change (in the positive or “brighter” direction, or the negative or “darker” direction) in the pixel signal at the output of the difference circuit relative to a reference pixel signal is greater than a corresponding predetermined voltage threshold value (also referred to herein as a “contrast threshold,” “nominal contrast threshold,” or “NCT”). It is appreciated that the described event driven readout circuit is one example implementation to read out event signals. Various implementations for readout circuitry and readout schemes for event vision sensor pixels are well known. Thus, details on circuitry and readout techniques for event driven circuits are largely omitted here for the sake of brevity and to avoid obscuring aspects of the present technology.

As shown, the event driven peripheral circuitry 114 can be arranged around the periphery of the event driven sensing array 112 in the middle die 104. In various examples, the event driven peripheral circuitry 114 can receive and process corresponding event detection signals. The depicted example also illustrates the column level connections for normal image readout 110 that are routed through the middle die 104 between the top die 102 and the bottom die 106.

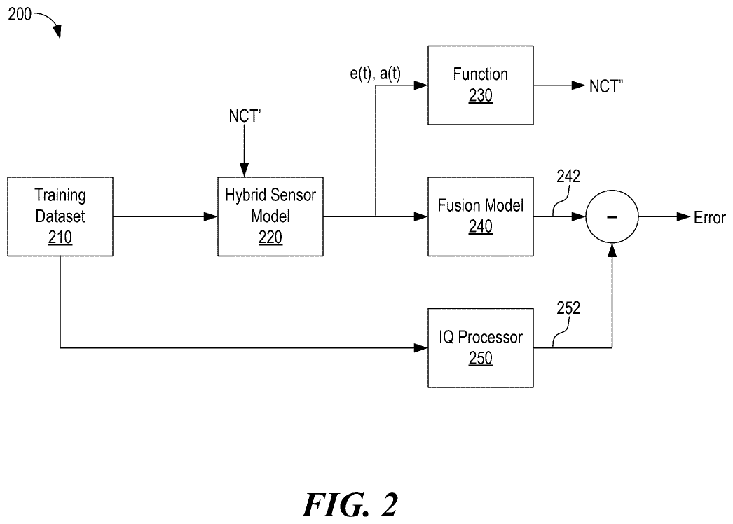

FIG. 2 is a schematic block diagram of a model training scheme 200 configured in accordance with embodiments of the present technology. As described in further detail herein, embodiments of the present technology can determine (e.g., automatically and/or in real-time) one or more optimal values of corresponding one or more sensor settings for event detection circuitry (e.g., the event driven circuits included in the event driven sensing array 112 of FIG. 1). One such sensor setting that can be optimized is contrast threshold values used by the threshold comparison stage. As discussed above with reference to FIG. 1, the threshold comparison stage may generate an event detection signal when a detected change in the pixel signal (e.g., at the output of a difference circuit) relative to a reference pixel signal is greater than a corresponding NCT. FIG. 2 illustrates the use of a learning model or learning algorithm to optimize the value of the NCT.

The model training scheme 200 can include a training dataset 210, a hybrid sensor model 220, a function 230, a fusion model 240, and an image quality (IQ) processor 250. The training dataset 210 can include images and/or videos to be used to train the hybrid sensor model 220, as discussed in further detail herein. For example, the training dataset 210 can originate from synthetic datasets (e.g., Blender, Neural Radiance Fields (NeRF), and/or the like), real images and/or videos (e.g., captured by a high-speed camera), or a combination thereof. The training dataset 210, along with an initial nominal contrast threshold value (NCT′) can be input to the hybrid sensor model 220. The hybrid sensor model 220 can then be run to detect events, if any, in the training dataset 210 based on the initial NCT′.

In some embodiments, to obtain a measure of the image/video quality of the captured external scene and/or the EVS data, the hybrid sensor model 220 can use the Video Multi-method Assessment Fusion (VMAF) video quality metric or another suitable video quality assessment metric (e.g., VideoDVP (Visual Difference Predictor, Color VideoDVP). For example, the fusion model 240 can produce an improved image stream 242, such as a deblurred image stream, a rolling-shutter-distortion-corrected image stream, an interpolated image stream, and/or the like. In some embodiments, the fusion model 240 uses event data (e(t)), ambient light (a(t)), and/or image frames (c(t)) output by the hybrid sensor model 220 as inputs. Continuing with the above example, the training dataset 210 can be input to the IQ processor 250 to produce ground truth data 252. In some embodiments, the IQ processor 250 can be configured to (i) adjust the resolution, color space, and/or the like and/or (ii) perform a temporal down-sampling of the training dataset 210. In turn, the improved image stream 242 can be compared against the ground truth data 252, which can serve as a reference, to generate a VMAF score. Thus, the measured image quality can be represented by Equation (1) below:

$$IQ ( m ( e , a , c , NCT ) ) = VMAF ( m ( e , a , c , NCT ) , GT ) \qquad ( 1 )$$

where IQ is the image quality metric, m is the improved image stream 242 output by the fusion model 240, e represents event signals, a represents ambient light signals, c represents frame signals, GT is the ground truth data 252 output by the IQ processor 250, and VMAF is the VMAF score obtained by comparing m against GT. The obtained VMAF score can represent the predicted subjective image/video quality of the captured external scene. Additional details associated with the VMAF video quality metric that are known in the art are omitted herein to avoid unnecessarily obscuring features of the present technology. It is appreciated that in other embodiments, a metric other than VMAF can be used to obtain a measure of the image/video quality of the captured external scene and/or the EVS data.

In some embodiments, once the image quality metric is obtained, the hybrid sensor model 220 can use the function 230 to determine an optimized nominal contrast threshold (NCT″). For example, the function 230 can be used to determine a value of the NCT that optimizes (e.g., improves or maximizes) the image quality metric IQ. In turn, the function 230 can set and output that value of the NCT as the optimized NCT″. Thus, the calculation of the optimized NCT″ can be represented by Equation (2) below:

$${NCT}^{″} = f ( e , a , NCT ) = arg {max}_{N C T} \vert IQ ( m ( e , a , c , NCT ) ) \vert \qquad ( 2 )$$

wherein f is the function 230. In some embodiments, the function 230 is a learning algorithm, such as a support vector machine (SVM) learning algorithm, a convolutional neural network (CNN) learning algorithm, and/or the like. Once the optimized NCT″ is determined, the optimized NCT″ can be communicated to event driven circuitry. Subsequently, the event driven circuitry can use the optimized NCT″ for detecting future events in an external scene, if any.

In some embodiments, the optimized NCT″ is determined using, along with ambient light signals, event signals obtained between individual CIS frames. EVS signals are often obtained more frequently than CIS signals (e.g., EVS signals can be obtained at about 1,000-10,000 frames per second while CIS signals can be obtained at about 60-100 frames per second). Therefore, embodiments of the present technology are expected to determine and communicate the optimized NCT″ with very low latency, thereby enabling hardware parameter optimization in real-time.

Finding the optimized NCT″ is expected to improve the event sensing capabilities of event driven circuitry of the image sensors. As discussed above, the sensitivity and accuracy of event driven circuitry detecting changes or events in a captured external scene is determined at least in part by contrast threshold values used in their comparison stages. Thus, if the contrast threshold values are set too low, the event driven circuitry may become overly sensitive, leading to false positives caused by noise, minor fluctuations, and/or irrelevant background changes. Conversely, if the contrast threshold values are too high, genuine events might be missed, resulting in false negatives and a failure to capture important occurrences. Therefore, determining the optimized NCT″ can be regarded as striking the optimal balance between sensor sensitivity and accuracy, which can be particularly important in applications such as surveillance, autonomous navigation, scientific monitoring, and/or the like. As discussed above, the model training scheme 200 of FIG. 2 can be used to train the hybrid sensor model 220 to develop and use the function 230 for identifying the optimized NCT″ for a given scene.

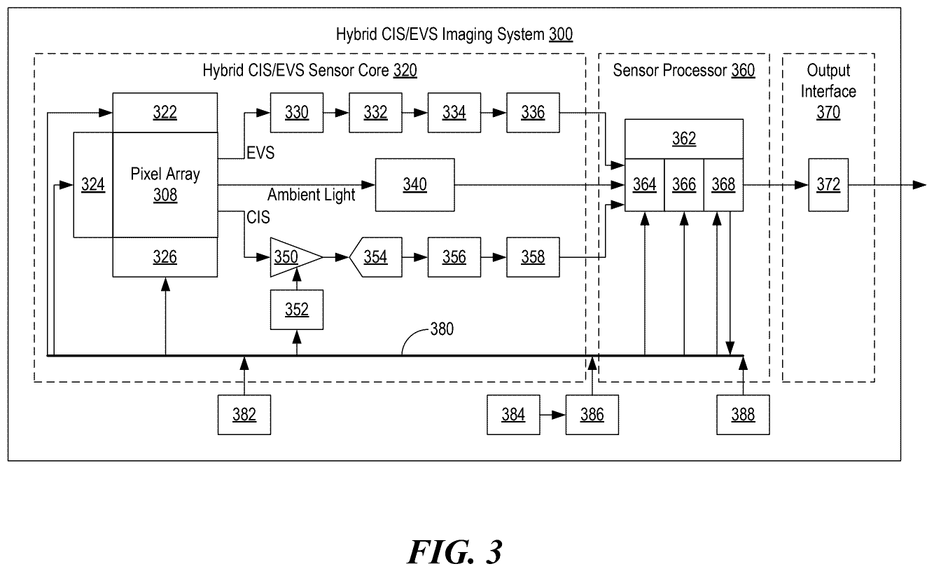

FIG. 3 is a schematic block diagram of a hybrid imaging system 300 (“the system 300”) configured in accordance with embodiments of the present technology. It is appreciated that the system 300 of FIG. 3 may be an example of the system 100 (or a portion thereof) of FIG. 1 and/or of other imaging systems configured in accordance with various embodiments of the present technology, and that similarly named and numbered elements described above are coupled and function similarly below. In particular, FIG. 3 illustrates an example hardware architecture that can be used to implement embodiments of the present technology. The system 300 can include a hybrid CIS/EVS sensor core 320, a sensor processor 360, and an output interface 370.

The hybrid CIS/EVS sensor core 320 can include a pixel array 308 (e.g., the pixel array 108 of FIG. 1) and a plurality of control circuits including a column control circuit 322, a row control circuit 324, a settings control circuit 326. Each of the control circuits 322, 324, 326 can be operably coupled to the pixel array 308 and can be configured to control various operational aspects thereof (e.g., column readouts, row readouts, configuring the pixel array 308 between CIS-only, hybrid CIS/EVS, and/or EVS-only modes).

The hybrid CIS/EVS sensor core 320 can also include circuitries for processing EVS signals or information, such as event driven circuits 330, a denoiser/filter 332, row and/or column scanners 334, and an event sensing processor (ESP) 336. As described above with reference to FIG. 1, the event driven circuits 330 can be operably coupled to the pixel array 308 and configured to receive photocurrent therefrom to determine events, if any, in the captured external scene. The denoiser/filter 332 can be operably coupled to the event driven circuits 330 and configured to reduce noise from and/or otherwise filter the event signals. The row and/or column scanners 334 can be operably coupled to the denoiser/filter 332 and configured to retrieve the event signals row-by-row and/or column-by-column. The ESP 336 can be operably coupled to the row and/or column scanners 334 and configured to further process the retrieved event signals to detect events. The event signals produced can be event data (e(t)) used, for example, by the fusion model 240 of FIG. 2.

Additionally, the hybrid CIS/EVS sensor core 320 can include one or more ambient light monitors 340 operably coupled to the pixel array 308 and configured to measure ambient light and generate corresponding ambient light signals. In some embodiments, the ambient light monitors 340 can be arranged around and/or in between individual pixels and/or groups of pixels of the pixel array 308. The ambient light signals produced can be ambient light (a(t)) used, for example, by the fusion model 240 of FIG. 2.

The hybrid CIS/EVS sensor core 320 can further include circuits for processing CIS signals or information, such as amplifiers 350, gain control circuits 352, ADC circuits 354, black level calibration circuits 356, and digital gain circuits 358. The amplifiers 350 can be operably coupled to the pixel array 308, the gain control circuits 352 can be operably coupled to the amplifiers 350, and the amplifiers 350 and the gain control circuits 352 can be configured to control the gain control or other form of amplification of the CIS signals. The ADC circuits 354 can be operably coupled to the amplifiers 350 and configured to convert the analog CIS signals to digital CIS signals. The black level calibration circuits 356 can be operably coupled to the ADC circuits 354 and configured to adjust and compensate for the baseline signal level (black level) to ensure accurate representation of pixel values in low-light or dark conditions. The digital gain circuits 358 can be operably coupled to the black level calibration circuits 356 and configured to amplify the digital CIS signals to achieve the desired brightness and dynamic range, ensuring proper signal scaling for further processing. The CIS signals can be image frames (c(t)) used, for example, by the fusion model 240 of FIG. 2.

The sensor processor 360 can be operably coupled to the hybrid CIS/EVS sensor core 320 and can include a buffer 362, a digital signal processor (DSP) 364, a decoder 366, and a sensor controller 368. The buffer 362, the DSP 364, and the decoder 366 can be configured to further process the event data (e(t)), the ambient light data (a(t)), and the CIS data (c(t)) received from the hybrid CIS/EVS sensor core 320. In turn, the sensor controller 368 can be configured to use the received event data (e(t)), ambient light (a(t)), CIS data (c(t)), and/or other received data (e.g., noise data) to determine an optimized value of a sensor setting. For example, correlating FIG. 3 with FIG. 2, the sensor controller 368 can implement the function 230 to find an NCT value that optimizes (e.g., improves, maximizes) image quality.

The output interface 370 can include a mobile industry processor interface (MIPI) 372 and/or other suitable interface component configured to transmit data to and/or from, for example, a host device. In some embodiments, the optimization (e.g., use of the function 230 of FIG. 2) is handled/executed by such a host device in addition to or in place of the sensor controller 368 performing such optimization, and the MIPI 372 can manage the communication of data therefrom and thereto.

The system 300 can further include a data bus 380, a timing generator and system control logic circuit 382, a serial interface 384, a control register bank 386, and a register 388. The data bus 380 can extend across the hybrid CIS/EVS sensor core 320 and the sensor processor 360. Functions of the serial interface 384, the control register bank 386, and the register 388 known in the art are omitted here to avoid unnecessarily obscuring aspects of the present technology. As shown, the data bus 380 can (i) receive data signals from the sensor controller 368, the timing generator and system control logic circuit 382, the control register bank 386, and the register 388 and (ii) transmit data signals to each of the control circuits 322, 324, 326, the gain control circuits 352, the DSP 364, the decoder 366, and the sensor controller 368. Therefore, once the sensor controller 368 (and/or a host device or other device) determines optimal value(s) of one or more sensor hardware setting(s), the optimal value(s) can be communicated to the relevant system component(s), such as the settings control circuit 326, and the relevant system component(s) can update their hardware settings to incorporate the optimal value(s).

In some embodiments, the optimization is performed multiple times, such as in a feedback loop, such that the sensor hardware parameters are regularly, periodically, or otherwise continuously optimized (e.g., in accordance with predefined intervals, in response to predetermined events, etc.). For example, the optimization can be performed once per CIS frame. In such embodiments, the NCT value may not change during event accumulation, which can be advantageous for performing, for example, deblurring operations. In another example, the optimization can be performed more than once per CIS frame. In such embodiments, the imaging system may exhibit improved event detection, object detection, and/or the like. In some embodiments, the optimization is performed prior to image and/or event capture, such as during a standby or idle mode.

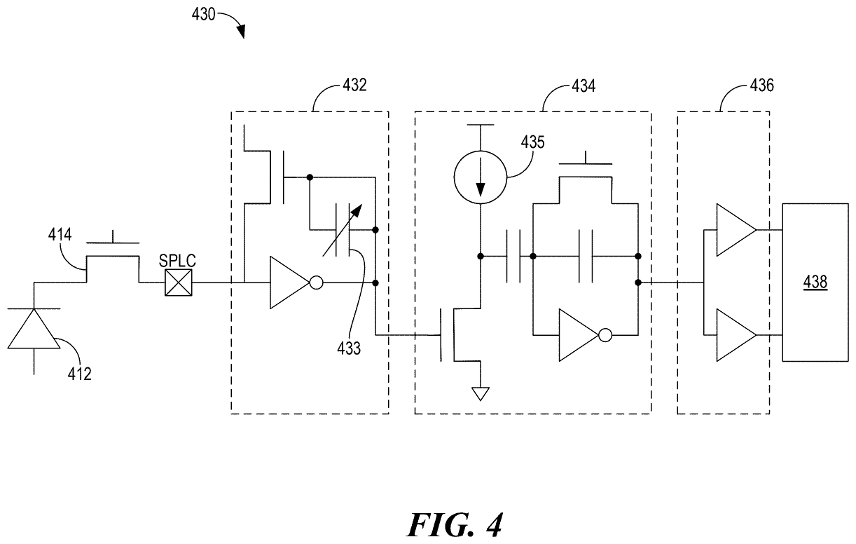

FIG. 4 illustrates an event driven circuit 430 configured in accordance with embodiments of the present technology. It is appreciated that the event driven circuit 430 of FIG. 4 may be an example of the event driven circuits (or a portion thereof) included in the event driven sensing array 112 of FIG. 1, the event driven circuits 330 of FIG. 3, and/or of other circuits configured in accordance with various embodiments of the present technology, and that similarly named and numbered elements described above are coupled and function similarly below. In particular, FIG. 4 illustrates various other sensor hardware settings that can be optimized in accordance with embodiments of the present technology, such as in addition to or in lieu of nominal contrast threshold.

As shown, the event driven circuit 430 can include a photocurrent-to-voltage converter 432, a difference circuit 434, a threshold comparison stage 436, and a logic and handshake circuit 438. The photocurrent-to-voltage converter 432 can be coupled to one or more photosensors 412 via an EVS transistor 414 and/or a stacked pixel level connection (SPLC). and the photocurrent-to-voltage converter 432 can be configured to convert photocurrent generated by the one or more photosensors 412 to a voltage. In some embodiments, the photocurrent-to-voltage converter 432 can be or include a logarithmic amplifier. The difference circuit 434 can be coupled to the photocurrent-to-voltage converter 432 and can be configured to (a) store a reference voltage at a reset time and (b) thereafter generate a difference signal or analog signal level (e.g., a logarithmic difference voltage relative to the reset time) based at least in part on the voltage from the photocurrent-to-voltage converter 432. The difference circuit 434 can therefore include memory elements (e.g., one or more capacitors) to store the reference voltage and/or the difference signal.

In some embodiments, the threshold comparison stage 436 includes an UP-event comparator and a DOWN-event comparator coupled in parallel between the difference circuit 434 and the logic and handshake circuit 438. In some embodiments, the threshold comparison stage 436 is coupled to multiple difference circuits (e.g., of multiple event driven circuits). The threshold comparison stage 436 can be configured to determine and generate event detection signals in response to events asynchronously detected in incident light received from the external scene. For example, the threshold comparison stage 436 can assert an event detection signal when an absolute value of the output signal of the difference circuit 434 is greater than a nominal contrast threshold, indicating that the corresponding pixel (e.g., the photosensor 412) has detected an event in the external scene. Event detection signals generated by the threshold comparison stage 436 can be output to the logic and handshake circuit 438. In turn, the logic and handshake circuit 438 can be configured to process the event detection signals. Additional details regarding photocurrent-to-voltage converters, difference circuits, threshold comparison stages, and logic and handshake circuits are provided in U.S. patent application Ser. No. 17/875,244, titled “LOW POWER EVENT DRIVEN PIXELS WITH ACTIVE DIFFERENCE DETECTION CIRCUITRY, AND RESET CONTROL CIRCUITS FOR THE SAME,” and filed on Jul. 27, 2022, the disclosure of which is incorporated by reference herein in its entirety.

As shown in FIG. 4, the photocurrent-to-voltage converter 432 can include a coupling capacitor 433, and the difference circuit 434 can include a current source 435. In some embodiments, the coupling capacitor 433 is a variable capacitor whose capacitance can be varied, for example, in response to control signals. Similarly, the current source 435 can be configured to supply a variable bias current (e.g., to a source follower transistor of the difference circuit 434). In operation, the capacitance of the coupling capacitor 433 and/or the current supplied by the current source 435 can affect noise levels observed in the event driven circuit 430. Moreover, the capacitance of the coupling capacitor 433 can affect the bandwidth of the event and pixel response latency, and the current applied by the current source 435 can affect the bandwidth of the event signal output. As such, these hardware settings can affect the event rate as measured by, for example, an event counter/analyzer circuit (e.g., reducing noise can reduce false positives). Accordingly, additional ways to improve image quality, in addition to or in lieu of optimizing nominal contrast threshold, can include optimizing values of the capacitance of the coupling capacitor 433 and/or the current supplied by the current source 435. For example, increasing the capacitance of the coupling capacitor 433 and/or increasing the current supplied by the current source 435 is expected to decrease noise observed within the event driven circuit 430 and thereby decrease mean event rate. In some embodiments, as discussed above, a feedback loop can be employed to continuously optimize these (and/or other) hardware settings.

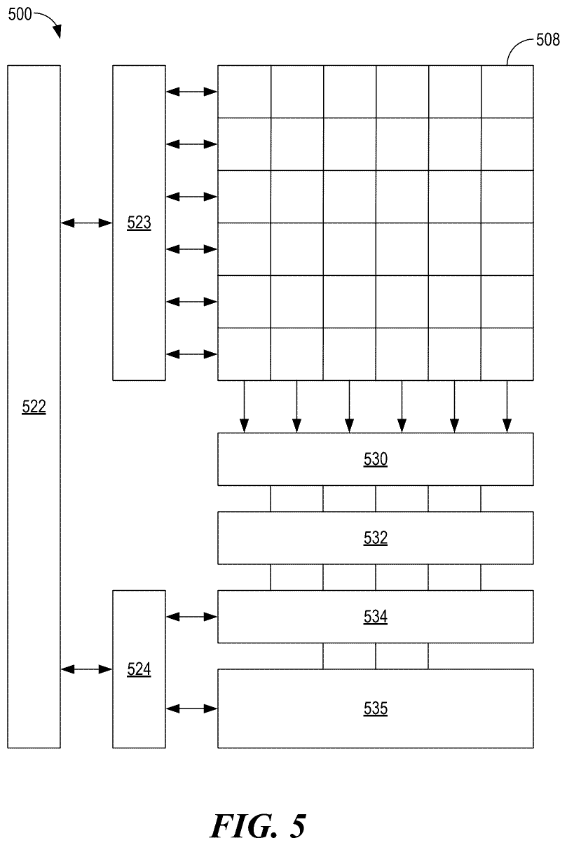

FIG. 5 is a schematic block diagram of an event detection portion of a hybrid CIS/EVS imaging system 500 (“the system 500”) configured in accordance with embodiments of the present technology. It is appreciated that the system 500 of FIG. 5 may be an example of the system 100 (or a portion thereof) of FIG. 1 and/or of other imaging systems configured in accordance with various embodiments of the present technology, and that similarly named and numbered elements described above are coupled and function similarly below. FIG. 5 illustrates an example hardware architecture that can be used to process EVS data in accordance with embodiments of the present technology. The system 500 can include a pixel array 508, a filtering and latch circuit 530, a denoise/noise counter circuit 532, an event counter/analyzer circuit 534, a row scanner 523, a column scanner 535, a row scanner manager 522, and a column scanner manager 524.

The pixel array 508 can include a plurality of pixels arranged in rows and columns. The filtering and latch circuit 530 can receive event signals from individual columns of the pixel array 508. The denoise/noise counter circuit 532 can count noise events in and obtain corresponding noise rate information from the event signals. In some embodiments, the denoise/noise counter circuit 532 includes a buffer memory for event mapping. The event counter/analyzer circuit 534, the row scanner 523, and/or the column scanner 535 can count the number of events detected in each row and/or column during a single event frame scan. For example, the event counter/analyzer circuit 534 can generate event rate information in the form of a table listing the number of events counted in each column and/or row. The event counter/analyzer circuit 534 can also find a standard deviation (sigma (c)) of the event rate by, for example, determining or using local event rate changes (e.g., differences in the event count between adjacent columns and/or rows).

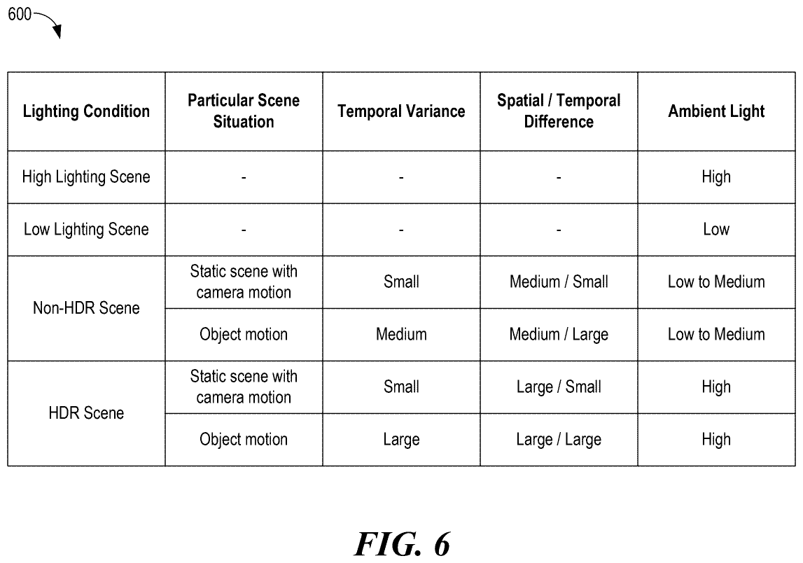

Accordingly, the system 500 can compute or provide various pieces of information, such as an event rate for each column/row, a mean event rate across multiple columns/rows, a standard deviation of the event rate between adjacent columns/rows, and noise rate information. As previously discussed above, ambient light data associated therewith can also be provided. The various pieces of information can be provided to downstream system components (e.g., the sensor controller 368 of FIG. 3) for performing one or more optimization sequences, such as using the function 230 of FIG. 2. Additionally, or alternatively, as discussed in further detail below with reference to FIG. 6, the system 500 can optimize sensor settings by using the various pieces of information described herein and determining the optimal values using a lookup table.

FIG. 6 is a table 600 listing various scene content parameters in accordance with embodiments of the present technology. As discussed further herein, the values listed in the table 600 can form benchmarks and/or portions of a lookup table that can be used in conjunction with embodiments of the present technology. As shown in the first column of the table 600, the external scene can have various lighting conditions such as a high lighting scene, a low lighting scene, a non-high dynamic range (HDR) scene, or an HDR scene. Events detected in the high lighting scene and the low lighting scene can be distinguished by ambient light level (e.g., high and low ambient light levels, respectively). Events detected in each of the non-HDR scene and the HDR scene can be further categorized by the particular scene situation, such as whether the event was detected in a static scene due to camera motion or due to object motion.

The columns of the table 600 further list (i) temporal variance and (ii) spatial and temporal differences. The temporal variance can correlate with the standard deviation of the event rates over time, discussed above with reference to FIG. 5. The spatial and temporal differences can correlate with (i) the standard deviation of the local event rate changes between adjacent rows and/or columns and (ii) the standard deviation of the event counts over time, respectively, also discussed above with reference to FIG. 5. At a high level, spatial information and ambient light levels are expected to differentiate scenes with different lighting conditions, and temporal information is expected to differentiate whether the event was detected due to camera motion or object motion. For example, as shown in the table 600, the spatial difference is expected to be at a medium level for non-HDR scenes and at a large level for HDR scenes, and the ambient light level is expected to be at low to medium levels for non-HDR scenes and at a high level for HDR scenes. As also shown in the table 600, the temporal difference is expected to be at a small level for events detected due to camera motion, whether detected in a non-HDR scene or an HDR scene, and at a medium or large level for events detected due to object motion.

The table 600 of FIG. 6 illustrates various scene types that are supported by sensor hardware setting optimization discussed herein in accordance with embodiments of the present technology. Referring to FIGS. 5 and 6 together, in some embodiments, the various pieces of information obtained via the system 500 and the table 600 can be used to optimize one or more hardware settings. For example, once spatial and/or temporal information are obtained, they can be compared against the “buckets” listed in the table 600 (e.g., low level, medium level, high level) to determine whether the detected scene is a high-lighting scene, a low-lighting scene, a non-HDR scene, and/or an HDR scene, and to determine whether the detected event originated from camera motion or from object motion. Once the lighting condition and/or the particular scene situation are determined, a lookup table with specific hardware optimization values (not shown in the Figures) can be referenced to determine optimal values for one or more sensor settings suitable for the given scene and/or situation. For example, a low-lighting scene, which may be expected to have higher noise levels than a high-lighting scene, can be associated with lower optimized values of the capacitance of the coupling capacitor 433 and/or the current supplied by the current source 435 (FIG. 4).

Accordingly, the lookup table methodology discussed herein with reference to FIGS. 5 and 6 can serve as an alternative to (or supplement) the function 230 described above with reference to FIG. 2. For example, different scenes and/or situations can be associated with different predetermined optimal values for nominal contrast threshold. Compared to using the function 230, the lookup table methodology may require fewer computations, thereby using fewer of the imaging system's computation resources. Compared to the lookup table methodology, use of the function 230 may yield more precise and tailored optimized values. In some embodiments, both the function 230 and the lookup table methodology can be employed such that the optimized value determined by each can be used to verify one another, averaged, and/or the like.

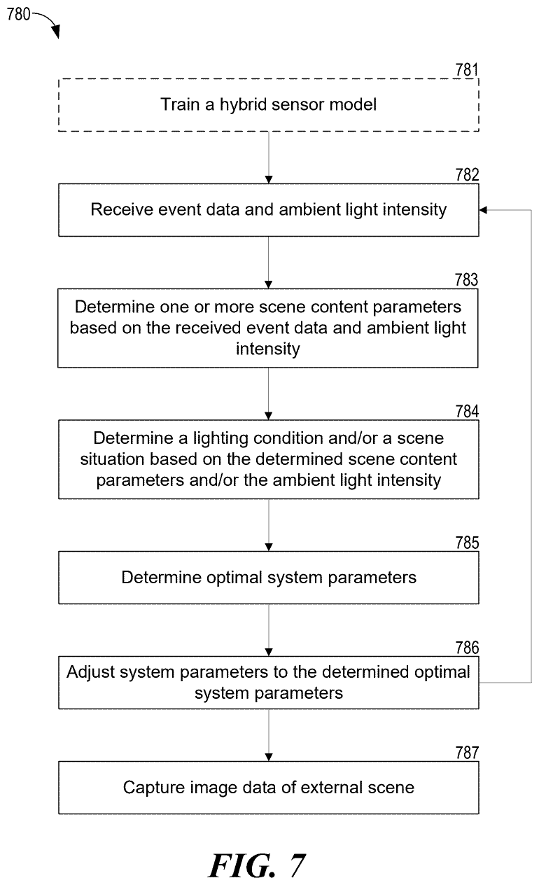

FIG. 7 is a flow diagram illustrating a method 780 of operating an imaging system in accordance with embodiments of the present technology. The imaging system may be an example of the system 100 (or a portion thereof) of FIG. 1 and/or of other imaging systems configured in accordance with various embodiments of the present technology. The method 780 is illustrated as a series of blocks or steps 781-787. All or a subset of one or more of the steps 781-787 can be executed in accordance with the description above and/or with the description that follows.

At block 781, the method 780 can optionally begin by training a hybrid sensor model (e.g., the hybrid sensor model 220 of FIG. 2). As discussed above in detail with reference to FIG. 2, a training dataset and an initial NCT value (NCT′) can be input into the hybrid sensor model, which can then be run to detect events, if any. An image/video quality metric, such as VMAF, can be calculated by comparing an image stream from the hybrid sensor model and ground truth data (e.g., output by an image quality processor). Then, the hybrid sensor model can use a function (e.g., a learning algorithm) to determine an optimized NCT value (NCT″) by finding the NCT value that, for example, improves or maximizes the image/video quality metric. Thus, the hybrid sensor model can be trained to find optimal system parameter values.

At block 782, the method 780 can continue (or optionally begin) by receiving event data and ambient light intensity from an external scene. The event data can include a history of events detected and their timestamps, if any. The ambient light intensity can indicate the brightness level and/or other details of the ambient light present in the external scene (e.g., as detected by ambient light sensors, such as ambient light sensors positioned at multiple different sections of the pixel array). In some embodiments, the event data is received via operation of the system of FIG. 3, the event driven circuit 430 of FIG. 4, the system 500 of FIG. 5, and/or the like.

At block 783, the method 780 can continue by determining one or more scene content parameters based on the received event data and ambient light intensity. As discussed above with reference to FIGS. 3 and 6, the one or more scene content parameters can include event rate, temporal variance in the event data, spatial/temporal differences in the event data, noise information, and/or the like. As discussed above, such scene content parameters can help identify the nature of any events detected, the external scene, etc.

At block 784, the method 780 can continue by determining a lighting condition and/or a scene situation based on the determined one or more scene content parameters and/or the ambient light intensity. The lighting condition can be a high lighting scene, a low lighting scene, a non-HDR scene, or an HDR scene. The scene situation can indicate the cause of any detected events, and can be a static scene with camera motion or a scene with object motion. As discussed above with reference to FIG. 6, the lighting condition and/or the scene situation can be identified based on whether each of the scene content parameters and/or the ambient light intensity is low/small, medium, or high/large. In some embodiments, block 784 is omitted and the method 780 can instead use the hybrid sensor model (e.g., the model trained at block 781) to more directly determine optimal values based on the event data and the ambient light intensity.

At block 785, the method 780 can continue by determining optimal system parameters. In some embodiments, the optimal system parameters are determined by a model. For example, if the step of block 781 was performed, the trained hybrid sensor model can use a function (e.g., a learning algorithm) to determine an optimal NCT value. In some embodiments, the optimal system parameters are determined based at least in part on the determined lighting condition and/or scene situation. For example, as discussed above with reference to FIG. 6, a lookup table that correlates the lighting condition and/or the scene situation to one or more optimal system parameters can be referenced.

At block 786, the method 780 can continue by adjusting system parameters to the determined optimal system parameters. For example, as discussed above with reference to FIG. 3, once the sensor controller 368 (and/or a host device or other device) determines optimal value(s) of one or more sensor hardware setting(s), the optimal value(s) can be communicated to the relevant system component(s) (e.g., the settings control circuit 326), and the relevant system component(s) can update their hardware settings to incorporate the optimal value(s). In some embodiments, the method 780 can return to block 782 to perform optimization multiple times, such as in a feedback loop, such that the sensor hardware parameters can be regularly, periodically, or otherwise continuously optimized (e.g., in accordance with predefined intervals, in response to predetermined events, etc.).

At block 787, the method 780 can continue by capturing image data of the external scene. The captured image data is expected to (i) have higher image/video quality and/or (ii) include event data with fewer false positives or false negatives compared to image data captured without use of the present technology.

Although the steps 781-787 of the method 780 of FIG. 7 are discussed and illustrated in a particular order, the method 780 is not so limited. In other embodiments, all or a subset of one or more of the steps 781-787 of the method 780 can be performed in a different order. Moreover, a person of ordinary skill in the relevant art will recognize that the illustrated method 780 can be altered and still remain within these and other embodiments of the present technology. For example, all or a subset of one or more of the steps 781-787 of the method 780 illustrated in FIG. 7 can be omitted and/or repeated in some embodiments. As another example, the method 780 can include one or more additional steps than shown in FIG. 7.

### C. CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. An imaging system, comprising:
a pixel array including a plurality of pixels arranged in rows and columns, each individual one of the plurality of pixels including a photosensor configured to generate photocurrent in response to incident light received from an external scene;
event detection circuitry operably coupled to the pixel array, wherein the event detection circuitry is configured to receive the photocurrent from one or more of the photosensors and output one or more event signals based at least in part on the received photocurrent and a contrast threshold, wherein each of the one or more event signals indicates an event detected in the external scene;
an ambient light monitor operably coupled to the pixel array, wherein the ambient light monitor is configured to output an ambient light signal indicating an ambient light level of the external scene; and
a sensor controller operably coupled to each of the event detection circuitry and the ambient light monitor, wherein the sensor controller is configured to:
receive the one or more event signals from the event detection circuitry and the ambient light signal from the ambient light monitor,
determine, based at least in part on the one or more event signals and the ambient light signal, an optimized value for the contrast threshold or another sensor setting of the event detection circuitry that is usable by the imaging system to improve an image quality of one or more images of the external scene, and
communicate the optimized value to the event detection circuitry.

2. The imaging system of claim 1, wherein the sensor controller is configured to determine the optimized value for the contrast threshold.

3. The imaging system of claim 1, wherein the sensor controller is configured to determine the optimized value using a learning algorithm.

4. The imaging system of claim 1, further comprising (a) an event counter or analyzer and (b) a row scanner or a column scanner, each operably coupled to the event detection circuitry, wherein (a) the event counter or analyzer and (b) the row scanner or the column scanner are configured to:
receive the one or more event signals from the event detection circuitry; and
determine, based at least in part on the one or more event signals, spatial and/or temporal event information associated with the external scene.

5. The imaging system of claim 1, wherein the sensor controller is configured to determine the optimized value based at least in part on one or more event occurrence rates, each event occurrence rate of the one or more event occurrence rates corresponding to a respective one of the rows or a respective one of the columns of the plurality of pixels.

6. The imaging system of claim 1, wherein the sensor controller is configured to determine the optimized value based at least in part on a mean of two or more event occurrence rates, each event occurrence rate of the two or more event occurrence rates corresponding to a respective one of the rows or a respective one of the columns of the plurality of pixels.

7. The imaging system of claim 1, wherein the sensor controller is configured to determine the optimized value based at least in part on a standard deviation of a plurality of event occurrence rates, each event occurrence rate of the plurality of event occurrence rates corresponding to a respective one of the rows or a respective one of the columns of the plurality of pixels.

8. The imaging system of claim 1, further comprising a denoiser operably coupled to the event detection circuitry, wherein the sensor controller is configured to determine the optimized value based at least in part on noise rate information generated by the denoiser.

9. The imaging system of claim 1, wherein the sensor controller is configured to determine the optimized value based at least in part on CMOS image sensor (CIS) information generated based at least in part on the photocurrent generated by at least a subset of the plurality of pixels.

10. The imaging system of claim 1, wherein:
the event detection circuitry includes (i) a photocurrent-to-voltage converter having a coupling capacitor with a variable capacitance, (ii) a difference circuit having a current source configured to generate a bias current, or (iii) a combination thereof;
the sensor controller is configured to determine the optimized value for the other sensor setting of the event detection circuitry; and
to determine the optimized value for the other sensor setting of the event detection circuitry, the sensor controller is configured to determine the optimized value for the variable capacitance and/or the bias current.

11. The imaging system of claim 1, wherein the sensor controller is configured to determine the optimized value for the contrast threshold or the other sensor setting of the event detection circuitry in between CMOS image sensor (CIS) frames.

12. The imaging system of claim 1, wherein:
the sensor controller is configured to communicate, in real-time, the optimized value to the event detection circuitry; and/or
the event detection circuitry is configured to, in real-time, adjust the contrast threshold or the other sensor setting of the event detection circuitry to the optimized value in response to the sensor controller communicating the determined optimized value to the event detection circuitry, thereby forming a feedback loop with the sensor controller.

13. The imaging system of claim 1, wherein the image quality of the one or more images of the external scene is based at least in part on a video quality assessment metric.

14. The imaging system of claim 1, wherein the sensor controller is configured to automatically determine and communicate optimized values for the contrast threshold or the other sensor setting at predefined intervals or in response to occurrence of one or more predetermined events.

15. A sensor processor for an imaging system, the sensor processor comprising:
a sensor controller operably couplable to event detection circuitry of the imaging system and to an ambient light monitor of the imaging system, wherein the sensor controller is configured, when coupled to the event detection circuitry and the ambient light monitor, to:
receive one or more event signals from the event detection circuitry and an ambient light signal from the ambient light monitor,
determine, based at least in part on the one or more event signals and the ambient light signal, an optimized value for a contrast threshold or another sensor setting of the event detection circuitry that is usable by the imaging system to improve an image quality of one or more images of an external scene, and
communicate the optimized value to the event detection circuitry.

16. The sensor processor of claim 15, wherein the sensor controller is configured to determine the optimized value using a support vector machine (SVM) learning algorithm or a convolutional neural network (CNN) learning algorithm.

17. The sensor processor of claim 15, wherein the sensor controller is configured to determine the optimized value based at least in part on one or more event occurrence rates, each of the one or more event occurrence rates corresponding to a respective row or column of a plurality of pixels operably coupled to the event detection circuitry.

18. The sensor processor of claim 15, wherein the sensor controller is configured to determine the optimized value based at least in part on a mean of two or more event occurrence rates, each of the two or more event occurrence rates corresponding to a respective row or column of a plurality of pixels operably coupled to the event detection circuitry.

19. The sensor processor of claim 15, wherein the sensor controller is configured to determine the optimized value based at least in part on a standard deviation of a plurality of event occurrence rates, each event occurrence rate of the plurality of event occurrence rates corresponding to a respective row or column of a plurality of pixels operably coupled to the event detection circuitry.

20. A method for operating an imaging system, the method comprising:
generating, using photosensors of a plurality of pixels included in a pixel array, photocurrent in response to incident light received from an external scene;
outputting, based at least in part on the photocurrent and a contrast threshold, one or more event signals, wherein each of the one or more event signals indicates an event detected in the external scene;
generating an ambient light signal indicating an ambient light level of the external scene;
determining, based at least in part on the one or more event signals and the ambient light signal, an optimized value for the contrast threshold or another sensor setting of the imaging system that is usable by the imaging system to improve an image quality of one or more images of the external scene; and
communicating the optimized value to a component of the imaging system for adjustment of the contrast threshold or the other sensor setting.

21. The method of claim 20, wherein determining the optimized value further comprises determining the optimized value based at least in part on (i) one or more event occurrence rates that each correspond to a respective row or a respective column of the plurality of pixels, (ii) a mean of multiple event occurrence rates of the one or more event occurrence rates, and/or (iii) a standard deviation of a plurality of event occurrence rates of the one or more event occurrence rates.

22. The method of claim 20, further comprising:
adjusting the contrast threshold or the other sensor setting to the optimized value; and
capturing the one or more images of the external scene while the contrast threshold or the other sensor setting is adjusted to the optimized value.
